(19) United States
(12) Patent Application Publication
(10) Pub. No.: US 2008/0204741 A1
(43) Pub. Date: Aug. 28, 2008

(54) Method for quantifying defects in a transparent substrate

(76) Inventors: Keith Mitchell Hill, Horseheads, NY (US); Randy LaRue McClure, Corning, NY (US); Richard Sean Priestley, Painted Post, NY (US)

Correspondence Address: CORNING INCORPORATED, SP-TI-3-1, CORNING, NY, 14831, US

(21) Appl. No.: 12/072,014

(22) Filed: Feb. 22, 2008

Related U.S. Application Data
(60) Provisional application No. 60/903,616, filed on Feb. 27, 2007.

(51) Int. Cl. G01N 21/00

(52) U.S. Cl. 356/239.7

(57) ABSTRACT

Disclosed is a method for the detection and quantification of defects in transparent substrates and, more particularly, in glass sheets. The method comprises providing a transparent planar substrate having a top surface and a bottom surface. The surface topography of at least a portion of the top surface of the provide transparent planar substrate is measured to obtain a three dimensional top surface profile having a sub-nanometer level of precision. From the three dimensional surface profile measurement, the existence of one or more surface variations in the three dimensional surface profile having an amplitude greater than a predetermined tolerance can be identified and/or quantified.

### CROSS-REFERENCE TO RELATED APPLICATIONS

This application claims the benefit of U.S. Provisional Application Ser. No. 60/903,616 filed on Feb. 27, 2007 and entitled “A METHOD FOR QUANTIFYING DEFECTS IN A TRANSPARENT SUBSTRATE”, the content of which is relied upon and incorporated herein by reference in its entirety.

### BACKGROUND

1. Field

The present invention relates to systems, methods, and apparatuses for the detection and quantification of defects in transparent substrates and, more particularly, in glass sheets.

2. Technical Background

Recently, significant attention has been focused on the detection of Mura defects in transparent substrates, such as glass sheets, primarily due to the popularity and acceptance of the liquid crystal display (LCD) television into the worldwide marketplace. As such, the industry is now challenged with meeting increased volume demands while delivering substrates that comply with stringent LCD mode specifications. Typically, defects such as streak, cord, and surface discontinuities are detected utilizing human inspectors and manual methods. However, with these current detection techniques, necessary levels of precision and accuracy required by current application specifications cannot be achieved.

For example, streak and cord attributes in LCD glass are physical abnormalities that can be observed through visual inspection. They consist of a sharp “microsurface” discontinuity that is typically manifested as a surface projection or depression, extending lengthwise in the direction of the glass draw. Streak defects typically appear as a single isolated line, whereas cord defects consist of multiple lines spaced every few millimeters. Cord defects typically consist of optical path length (OPL) variations as small as a few nanometers with periods of a few millimeters. These small variations, resulting from thickness or refractive index variations, modulate the light intensity on the screen by an effect commonly referred to as lensing. Streak features on the glass surface affects the optical properties of the finished panel by introducing a variation in the cell gap thickness.

Manual inspection is currently performed for characterizing cord and streak features. For example, in the detection of defects such as cord and streak in glass substrates used in liquid crystal displays, a shadow method is used to detect the defects. According to this method, a sheet of glass (typically about 1 meter wide.times.2 meters long) is mounted in a freely rotating L-bracket stand and illuminated by a xenon light source. The light source is diverging to illuminate the entire sheet. The shadow of the glass is viewed on a white screen by an inspector. The defects appear as one dimensional lines of contrast on the screen. The direction of the lines is parallel to the direction the glass sheets are drawn, for example in a downdraw apparatus in which glass sheets are manufactured. Once a defect is identified, the inspector holds a limit sample next to the defect area in the sheet and compares the images on the white board to decide whether the streak feature is light or dark. However, new streak specifications proposed for different LCD modes are as 20 nm (IPS mode), 30 nm (VA mode), and 40 nm (TN). Because the current technique is manual, an operator is unable to discern such closely spaced streak heights (i.e., 20, 30 & 40 nm streak heights).

Another approach previously developed to quantify streak in LCD glass uses a collimated laser beam that is directed through one side of the glass, exits the glass on the other side and is then focused onto a photodetector. A streak defect in the glass introduces a phase modulation of the laser beam resulting in a diffraction grating type optical effect. The diffracted beams constructively and destructively interfere as they propagate through the glass causing a light intensity variation on the photodetector that is dependent on the streak amplitude. However the net intensity variation seen by the photodetector is a function of the averaged streak amplitude on both sides of the sheet. Therefore single-sided streak amplitude, in particular for a sheet with asymmetric streak, cannot be provided from this technique.

Still further, another approach previously used to measure streak defects involves the use of a contact surface profilometer. However, the use of the contact surface profilometer was limited in its ability to measure streak defects down to the tolerable heights established by the industry.

Surface Discontinuities are inclusions embedded in the body of the glass. These inclusions can be silica or platinum matter or gas bubbles, either in a solid or gaseous form. Large inclusions, or those near the glass surface, can cause surface irregularities or discontinuities that protrude through the surface. The industry is concerned about the size of such inclusions because of undesired pixel blockage in the finished LCD panel. However, similar to the concerns of streak height, knowledge of the inclusion height can be critical since such defects can introduce a localized cell gap thickness variation which becomes visible in the finished LCD panel. Currently no methods exist in manufacturing for quantifying the height of surface discontinuities, such as embedded silica or platinum inclusions.

Repeatable and reliable visual inspection of cord and streak defects has proven to be extremely difficult, especially using manual methods, and has similarly been unable to achieve the necessary levels of precision and accuracy needed to meet today's industry standards. Accordingly, it would be desirable to provide an apparatus, system, and/or methods capable of measuring one-dimensional optical path length variations of transparent substrates capable of meeting the industries increased demands.

### SUMMARY

The present invention provides a method for identilying and quantifying the location and amplitude of surface defects, and more particularly, Mura defects, which can occur in the surface of transparent substrates such as glass sheets.

In particular, the method comprises the steps of providing a transparent planar substrate having a top surface and a bottom surface. The surface topography of at least a portion of the top surface of the transparent planar surface is then measured to obtain a three dimensional top surface profile having a sub-nanometer level of precision. From the surface profile measurement, the existences of one or more surface variations in the three dimensional surface profile having an amplitude greater than a predetermined tolerance can be identified and quantified.

In one aspect, the method of the present invention utilizes optical interferometry to obtain the surface topography measurements. By utilizing optical interferometry in combination with mathematical algorithms, the present invention is further capable of eliminating operator-to-operator subjectivity during data analysis which previously has reduced the overall measurement repeatability and reproducibility of the conventional measurement techniques. This improved repeatability, combined with increased precision and accuracy of the inventive method, can enable a more reliable method of detecting and quantifying surface defects in a particular substrate.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “imaging device” includes embodiments having two or more such imaging devices unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be farther understood that the endpoints of each of the ranges are significant both in relation to the other endpoint, and independently of the other endpoint.

As briefly summarized above, the present invention provides a method for quantifying-defects in a transparent planar substrate and, in particular, in a glass sheet material such as that used in liquid crystal displays (LCD's). The particular defects for which the instant method can be used to detect and/or quantify include, without limitation, Mura defects such as streak, cord, and surface discontinuities. To this end, as one of skill in the art will appreciate, “Mura” is a Japanese term for blemish and is conventionally used in the display industry to describe visual defects in liquid crystal displays. The existence of such Mura defects, like Streak, Cord, and Surface Discontinuity, can result in a thickness non-uniformity of the LCD cell gap and can cause a visible uneven light intensity through the display device. When viewed by the human eye, this uneven light distribution can result in a contrast variation between the defect region and the surrounding normal area of the glass panel.

As used herein, streak defects refer to a “microsurface” discontinuity that is typically manifested as a surface projection or depression, extending lengthwise in the direction of the glass draw. Streak defects typically appear as a single isolated line, whereas cord defects consist of multiple lines spaced every few millimeters. These small variations, resulting from thickness or refractive index variations, can modulate the light intensity on the screen by an effect commonly referred to as lensing.

As used herein, surface discontinuity defects refer to and include inclusions of matter, such as silica and or platinum matter, in the surface of the substrate.

The method of the present invention comprises first providing a transparent planar substrate having a top surface and an opposed bottom surface, which, as set forth above can in one aspect be a glass sheet material. The substrate itself can also have any desired size, shape and/or thickness. The surface topography of at least a portion of the top surface of the transparent planar substrate is then measured in order to obtain a three dimensional top surface profile of the substrate. The surface topography can be acquired using any conventional technique suitable for obtaining three dimensional surface topography measurements. For example, in one aspect, the surface topography of the top surface can be obtained using optical interferometry. Still further, in another aspect, it is desired that the optical interferometer have the capability to measure the surface topography with a resolution of up to 0.1 nm. An exemplary and non-limiting commercially available optical interferometer suitable for obtaining the surface topography of the substrate is the Zygo NewView 6200 Optical Profilometer, available from the Zygo Corporation, Middlefield, Conn., USA. The Zygo NewView 6200 is a high precision microscope that uses white light interferometry to generate a three-dimensional image of a test surface. The optical interferometric data collected onto a charged coupled device (CCD) camera is processed to generate a high resolution, three dimensional surface map in the nanometer to micron scale that is representative of the surface topography under examination for defects.

Once the three dimensional surface topography data has been acquired, the surface topography data can then be used to identify one or more surface variations in the three dimensional surface profile having an amplitude greater than a predetermined tolerance to thereby detect and/or quantify the existence of one or more surface defects in the top surface of the transparent planar substrate. In particular, once the surface map is generated, quadratic polynomial equations can be applied to the measurement data to compute the height and width of a Streak or Surface Discontinuity defect. In one aspect, the first and second derivative of the profile can be calculated, which correspond to the rate at which the surface topography changes per a specified distance across the captured profile. The maximum and minimum values of the defect in question and thus the defect height can be determined from the derivative profiles.

Exemplary algorithms which can be used to determine a defect location and amplitude (referred to hereinafter as “Peak” and “Valley”) are the Peak Detector algorithms commercially available from National Instruments, Austin, Tex., USA. These algorithms fit a quadratic polynomial to sequential groups of data points obtained from the surface topography plot and test the fit against an established threshold level. In particular, a given cross section of the obtained surface topography is analyzed for X-Z axis profile data. This profile data can first be leveled to eliminate any residual tilt by first applying a conventional least squares linear fit regression model to the profile. After leveling the profile data, a calculation of a first derivative moving window is applied across the profile data. While any size moving window can be applied, in one aspect it is preferred to use a 4 mm wide window size. A second derivative moving window is then applied to the profile data obtained from the first derivative calculation. The amplitude of the “Peak” and “Valley” inflection points of this second derivative plot can then be used to determine whether the streak feature is a surface depression or projection. This determination can also be verified by examining the “Peak” and “Valley” inflection points of the first derivative plot as well. The “Peak” and “Valley” inflection points of the first derivative plot are then used to determine the maximum deviation location of the identified streak feature. Still further, the “Peak” and “Valley” inflection points of the second derivative plot are also used to determine the X-axis locations of the profile that will be used to establish a baseline against which the streak amplitude is calculated.

The aforementioned process for quantifying one or more Streak parameters can also be used to quantify the amplitude of Surface Discontinuity. However, in an alternative aspect, a simplified process for calculating Surface Discontinuity can be used. In particular, the collection of surface topography data on and around the subject surface discontinuity defect can result in the creation of relatively flat background profile data. Thus, according to an exemplified extraction process, the peak amplitude of a Surface Discontinuity can be first determined. The minimum profile amplitude locations on both sides of the peak amplitude can then be determined. A linear fit can then be performed using those points and subtracted from the profile data to quantify the amplitude of the Surface Discontinuity.

By utilizing an optical profilometer having a sub-nanometer level of precision, the method of the present invention is capable of identifying and quantifying one or more surface defects having an amplitude as small as approximately 5 nm. Accordingly, in one aspect, the method of the present invention is capable of identifying and quantifying one or more surface defects having an amplitude greater than or equal to 5 nm. Still further, the method can be used to identify and quantify a defect having an amplitude in the range of from 5 nm to 100 nm. Still further, the increased level of procession achieved by the instant method is capable of eliminating operator-to-operator subjectivity that results from conventional data analysis. As a result, the present invention further provides improved repeatability and accuracy.

It will also be appreciated upon practicing the method of the present invention that an optical interferometer, such as the Zygo NewView 6200 is capable of measuring the surface topography of a single surface of a substrate without influence from the topography of an opposed substrate surface. In contrast, conventional techniques for identifying defects relied on light that was transmitted through the substrate and an averaged defect value was computed with no capability in separating out height contributions from individual sides. This disadvantage with conventional techniques can be even more problematic in instances where defect amplitudes on opposing sides of a substrate are asymmetric. Accordingly, using conventional techniques, it is possible to obtain erroneously ‘Good’ results.

Lastly, it should be understood that while the present invention has been described in detail with respect to certain illustrative and specific embodiments thereof, it should not be considered limited to such, as numerous modifications are possible without departing from the broad spirit and scope of the present invention as defined in the appended claims.

1. A method for quantifying defects in a transparent planar substrate, comprising the steps of:
providing a transparent planar substrate having a top surface and a bottom surface;
measuring the surface topography of at least a portion of the top surface of the transparent planar surface to obtain a three dimensional top surface profile having a sub-nanometer level of precision; and
identifying one or more surface variations in the three dimensional surface profile having an amplitude greater than a predetermined tolerance to thereby quantify one or more top surface defects in the top surface of the transparent planar substrate.

2. The method of claim 1, wherein prior to identifying one or more surface variations, a derivative of the three dimensional surface profile is first calculated corresponding to a rate at which the surface topography changes for a selected distance across the three dimensional surface profile, and wherein the amplitude of the identified one or more surface variations is determined from the determined derivative.

3. The method of claim 1, wherein the surface topography of the top substrate surface is measured by optical interferometry.

4. The method of claim 1, wherein the one or more identified defects comprise a Mura defect.

5. The method of claim 1, wherein the Mura defect comprises streak and/or surface discontinuity.

6. The method of claim 5, wherein the identified Mura defect is a surface discontinuity defect comprising an inclusion of silica and or platinum matter in the substrate.

7. The method of claim 5, wherein the identified Mura defect is a streak defect and comprises a lengthwise extending surface projection and/or depression.

8. The method of claim 1, wherein the method is capable of identifying one or more surface defects having an amplitude greater than 5 nm.

9. The method of claim 8, wherein the method is capable of identifying one or more surface defects having an amplitude in the range of from 5 nm to 100 nm.

10. The method of claim 1, wherein the identification of one or more defects in the top surface of the substrate occurs without influence from the bottom surface of the substrate.
